(19) United States
(12) Patent Application Publication
(10) Pub. No.: US 2020/0394532 A1
(43) Pub. Date: Dec. 17, 2020

(54) Detaching Social Media Content Creation from Publication

(71) Applicant: International Business Machines Corporation, Armonk, NY (US)

(72) Inventors: Chris Kau, Mountain View, CA (US); Robert Huntington Grant, Atlanta, GA (US); Gary Denner, Leiklip (IE); Jonathan D. Dunne, Dungarvan (IE)

(73) Assignee: International Business Machines Corporation, Armonk, NY (US)

(21) Appl. No.: 16/441,072

(22) Filed: Jun. 14, 2019

(51) Int. Cl. G06N 5/04; G06N 20/00; G06N 5/02; G06F 16/958

(52) U.S. Cl. CPC G06N 5/04; G06F 16/958; G06N 5/02; G06N 20/00

(57) ABSTRACT

Embodiments relate to an intelligent computer platform to detach content creation from content publication. Content creation is detected prior to the content being published on a platform. One or more publication platforms are monitored in real-time identifying and analyzing published content. A model is derived to infer a temporal delay for publishing the detected content. Publication of the detected content is scheduled based on the derived model and temporal inferred delay. The detected content is then published at a time identified by the inferred delay, wherein publication of the content separates the content creation from the content publishing.

### BACKGROUND

The present embodiments relate to a system, computer program product, and method for detaching content creation from content publication. More specifically, the embodiments relate to masking behavior with respect to publication. The publication system and process shown and described herein conducts topic analysis and modeling of content to be posted and in one embodiment conducts modeling of publication venues, and leverages the modeling to schedule publication.

SUMMARY

The embodiments include a system, computer program product, and method for detaching content creation from content publication.

In one aspect, a computer system is provided with a processing unit and memory for use with an artificial intelligence (AI) computer platform to detach content creation from content publication. The processing unit is operatively coupled to the memory and is in communication with the AI platform and embedded tools, which include a content manager, a platform manager, and a director. The content manager functions to detect content creation prior to being published on a platform. The platform manager functions to monitor one or more publication platforms in real-time and identify and analyze content published on the platforms. The director derives a model to infer a temporal delay to publish the detected content to the one or more publication platforms based on the monitoring of the platforms by the platform manager. The director further schedules the publication of the detected content based on the derived model and inferred temporal delay. The detected content is then published to the designated publication platforms by the director at a time identified by the inferred delay. The publication separates content creation from content publication.

In another aspect, a computer program device is provided to detach content creation from content publication. The program code is executable by a processing unit to detect content creation prior to being published on a platform. The program code monitors one or more publication platforms in real-time and identifies and analyzes content published on the platforms. The program code derives a model to infer a temporal delay to publish the detected content to the one or more publication platforms based on the monitoring of the platforms. The detected content is then published to the designated publication platforms at a time identified by the inferred delay. The program code separates content creation from content publication.

In yet another aspect, a method is provided for detaching content creation from content publication. Content creation is detected prior to the content being published on a platform. One or more publication platforms are monitored in real-time including identifying and analyzing published content on the monitored platforms. A model is derived to infer a temporal delay for publishing the detected content to the one or more monitored publication platforms. Publication of the detected content is scheduled based on the derived model and temporal inferred delay. The detected content is then published at a time identified by the inferred delay wherein publication of the content separates the content creation from the content publishing.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating an artificial intelligence platform computing system.

FIG. 2 depicts a block diagram illustrating the artificial intelligence platform tools, as shown and described in FIG. 1, and their associated application program interfaces.

FIG. 3 depicts a flow chart illustrating a process for scheduling content publishing to a publication platform.

FIG. 4 depicts a flow diagram illustrating an aspect of scheduling content for publication on one or more publication platforms.

FIG. 5 depicts a block diagram illustrating an example of a computer system/server of a cloud based support system, to implement the system and processes described above with respect to FIGS. 1-4.

FIG. 6 depicts a block diagram illustrating a cloud computer environment.

FIG. 7 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Social media is a computer based technology that facilitates the sharing of ideas, thoughts, and content through the building of virtual networks and communities. There are a variety of social media platforms, also referred to herein as publication platforms, each supporting receipt and exhibition of content from subscribers to the community. Content includes various forms of communication, such as documents, photographs, and videos. Data from publication platforms comprises uni-directional messages, bi-directional messages, or broadcast communications. Tools are provided to support and enable publishing content to one or more publishing platforms, such as social media venues, and even scheduling an optimal time for publishing on a designated platform. The tools evaluate the content with respect to publication and schedule the content for publication on one or more venues based on the content evaluation. Accordingly, as shown and described herein, and articulated in the attached drawing figures, tools, program code, and processes are provided to analyze content and apply the analysis to publishing or communicating associated content.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language systems (such as the IBM Watson® artificially intelligent computer system or other natural language interrogatory answering systems) process natural language based on system acquired knowledge. To process natural language, the system may be trained with data derived from a database or corpus of knowledge, but the resulting outcome can be incorrect or inaccurate for a variety of reasons.

Machine learning (ML), which is a subset of Artificial intelligence (AI), utilizes algorithms to learn from data and create foresights based on this data. More specifically, ML is the application of AI through creation of neural networks that can demonstrate learning behavior by performing tasks that are not explicitly programmed. Deep learning is a type of ML in which systems can accomplish complex tasks by using multiple layers of choices based on output of a previous layer, creating increasingly smarter and more abstract conclusions.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly.

In the field of information technology (IT), electronic publication platforms are commonly utilized for communication and dissemination of content. Examples of such publication platforms include, but are not limited to, social media platforms. These publication platforms provide a virtual environment to support and enable publication of content of various topics and forms. Different publication platforms may be directed to different communities, e.g. personal, professional, etc. Content published on one platform may not be appropriate on a different platform. Similarly, there may be an overlap of content across different platforms.

It is understood that these platforms as characterized by the published content are dynamic. As content is received and published, the character of the platform is subject to change. A subject that experiences a surge in popularity on one or more publication platforms for a limited duration of time is referred to as trending. There is no time limit as to how long a topic remains popular, although it is understood in the art that trending topics tend to have a limited duration. Trending topics may be identified on the publication platform(s) with corresponding indicia. Depending on the content to be published, monitoring trends and trending topics may facilitate identifying an optimal time to schedule the publication. Accordingly, one of the factors associated with content publication scheduling may employ evaluating trends and trending topics as platform characteristic data.

As shown and described herein, a system, method, and computer program product are provided and directed at AI and cognitive computing for decision making with respect to content publication and scheduling. The content publication scheduling incorporates content characteristic data with evaluation of content to be published and dynamic platform characteristics. As shown and described in detail below, the AI and cognitive computing includes a real-time assessment of one or more publication platforms and analysis of published content, and leverages the real-time assessment to determine an optimal time for publication of content. Accordingly, the system and processes shown and described in detail below demonstrate use of AI and cognitive computing to account for platform identification, determine optimal timing and platform(s) for publication, and facilitate execution of corresponding publication requirements.

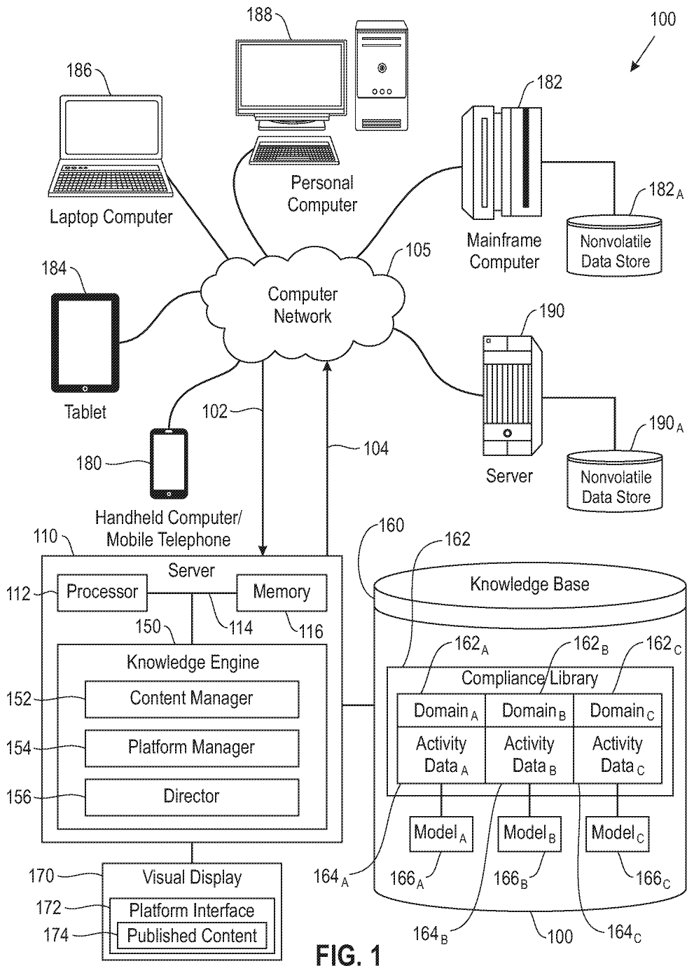

Referring to FIG. 1, a schematic diagram of an artificial intelligence platform computing system (100) is depicted. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform, referred to herein as a knowledge engine (150), for cognitive computing, including natural language processing, over the network (105) from one or more of the computing devices (180), (182), (184), (186), (188), and (190). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The knowledge engine (150) is shown herein configured with tools to enable separation of content creation from content publication. The tools function to evaluate the content to be published and one or more platforms for publication venues, and design a model and corresponding publication schedule. The tools include, but are not limited to, a content manager (152), a platform manager (154), and a director (156). The knowledge engine (150) may receive input from the network (105) and leverage a data source (160), also referred to herein as a corpus or knowledge base, to selectively access activity data. As shown the data source (160) is configured with a library (162) with a plurality of models that are created and managed by the director (156). Details of how the models are created are shown and described in detail below. It is understood that different domains, such as different platform entities, may each be classified as a domain. In the example shown herein, a plurality of domains are shown with corresponding models. The domains include, but are not limited to, domain_{A} (162_{A}), domain_{B} (162_{B}), and domain_{C} (162_{C}). Although only three domains are shown and represented herein, the quantity should not be considered limiting. In one embodiment, there may be a different quantity of domains. Similarly, domains may be added to the library (162) as models are derived by the director (156). Corresponding activity data is identified or otherwise tracked for each domain, and shown herein as activity data_{A} (164_{A}), activity data_{B} (164_{B}), and activity data _{C} (164_{C}). Furthermore, each domain and the corresponding or associated activity data is captured and categorized in the form of models with respect to each of the domains by the director (156). As shown, domain_{A} (162_{A}) includes model_{A} (166_{A}), domain_{B} (162_{B}) includes model_{B} (166_{B}), and domain_{C} (162_{C}) includes model_{C} (166_{C}).

It is understood that the cognitive computing employed herein leverages data from one or more sources, such as the data source (160), and in one embodiment one or more of the publication platforms. As shown herein, the data source is referred to as the knowledge engine (160) and is configured with domains and logically grouped activity data in the form of models. The content manager (152) functions to detect, and in one embodiment collect or extract data that has been or is in the process of being created, with the detection taking place prior to publishing the detected content on a publication platform. In one embodiment, the content being created may be from the various computing devices (180), (182), (184), (186), (188), and (190) in communication with the network (105). The platform manager (154) functions to interface with one or more publication platforms. More specifically, the platform manager (154) monitors the one or more publication platforms in real-time to facilitate evaluation of content being published on the platform. The platform manager (154) identifies and analyzes the published content on the platforms that are the subject of the monitoring. The director (156), which is shown herein operatively coupled to the platform manager (154), derives a model, e.g. model_{A} (166_{A}), model_{B} (166_{B}), and model_{C} (166_{C}). Each of the models functions as a representation of the respective platform and corresponding platform behavior. In one embodiment, the director (156) leverages an existing model for the publication platform and either updates the model or modifies the model to reflect current platform behavior. Accordingly, the director (156) organizes or arranges the platform behavior data into one or more of the corresponding models.

The models reflect and organize activity and publication data corresponding to the respective platform. Examples of such activity and publication data may vary. For example, the platform may support a blog where an individual or entity may submit content and content entries on a specific topic, description of events, graphics, video, etc. The platform may support a comment(s), which is a form of a response that is often provided as an answer or reaction to a blog post or message on the corresponding platform. The platform may support a forum, also known as a message board or an online discussion site. The platform may support social media monitoring, which is a process of monitoring and responding to mentions related to a business that occurs in social media or other publication platforms. These are merely examples of content that may be supported on the platform that is the subject for content publication. The director (156) leverages the platform data gathered by the platform manager (154) and either updates an existing model for the platform or derives a new model for the platform. Whether it is a new model or an updated model, the director (156) maintains a copy of the model in its new or updated state in the knowledge base (160).

The director (156) leverages the new or updated model to infer a temporal delay to publish content to the corresponding platform. The current state of the platform reflects trending topics, which refers to current content. More specifically, the trending topic refers to a subject that experiences or is experiencing a surge in popularity on one or more platforms for a limited duration of time. For example, with respect to electronic commerce, a business entity may check platforms and corresponding trends and trending topics to ascertain consumer interest and capitalize on the current conversation. It is understood that the entity that created the content, hereinafter referred to as the content owner, that is the subject of being published may desire that the publication somehow responds to the current state. For example, the owner may want the content published to follow the current trend, also known as a follower, the owner may want the content published to create a new trend, also known as a trend setter, or the owner may want the content randomly published. The temporal delay inferred in the model reflects the owner or setting created by the owner that identifies the state of the content to be published, e.g. follower, trend setting, or random. Accordingly, the inferred delay bridges the state of the platform with the owner setting(s).

The director (156) uses the inferred delay identified by the model to schedule publication of the content that was either identified or otherwise detected by the content manager (152). The scheduled publication is platform specific. The director (156) may utilize multiple accounts, including a first account for a first platform and a second account for a second platform, and schedule the publication with the first and second accounts to the respective platforms. It is understood that different platforms may have different states or different trends. The model reflects the state of the individual platforms. The temporal delay for the same content may be different for each individual platform. For example, there may be a first temporal delay for publishing the content on a first platform and a second temporal delay for publishing the content on a second platform. In one embodiment, the publication may be sent to multiple platforms from a single owner account. Regardless of the configuration of accounts and platforms, the director (156) publishes the content to the designated platforms at the time identified by the model. By creating or leveraging the model by the director (156) and by monitoring publication platform(s) by the platform manager (154), publication separates content creation from content publication.

Publishing and publishing times of content may be considered in reference to the respective platforms and the content. For example, the director (156) may be evaluating two different sets of content, referred to herein as first content and second content, to the same platform or even to different platforms. The director (156) evaluates and identifies characteristic data of each set of content, and infers temporal delays for publication of each set of content. In one embodiment, the inferred temporal delay for the first content may be different from the temporal delay for the second content, and in one embodiment, the inferred temporal delay may be the same for the first and second content. The director (156) is responsible for coordinating the temporal delays of each content set based on the content evaluation and the platform behavior. Accordingly, the director (156) and the corresponding content publication schedule may be multi-dimensional with respect to management of multiple content sets across a single platform or multiple platforms.

A visual display (170) is operatively coupled to the server (110) or in one embodiment, operatively coupled to one or more of the computing devices (180)-(190) across the network connection (104). The visual display functions to exhibit one or more platforms and published content with respect to the platform(s). In the example shown herein, the visual display (170) is provided with a platform interface (172) that exhibits the published content (174). As content is processed by the content manager (152) and the director (156) and published to a corresponding platform, the director (156) reflects the publication and content characteristics in the corresponding model. In one embodiment, the director (156) updates the corresponding model to reflect the published content on the respective platform. Accordingly, each model configured and operatively coupled to the knowledge engine (150) is dynamically updated by the director (156).

Content subject to publication may come in different forms, including but not limited to text, images, and video. In one embodiment, natural language processing (NLP) is employed by one or more of the tools, including the content manager (152), the platform manager (154), and the director (156) to interpret the content, including but not limited to, interpreting an expression. For example, the publication content may be subject to parsing to identify content components, parts of speech, analogies, patterns, expressions, etc. A sentence parsing tool, such as but not limited to slot grammar logic (SGL), may be applied to the publication content to separate the publication content into its constituent parts to find the sentence parts and location sequence. Accordingly, one or more NLP tools are utilized to parse the publication content and the platform content to identify grammatical components and expressions therein.

It is understood that data may be collected at periodic intervals, with the content manager (152) collecting the data or changes in the data and the director (156) reflecting the collected or changed data in an appropriately classified or operatively coupled model. In one embodiment, the content manager (152) may function in a dynamic manner, including, but not limited to, detecting changes to data, and collecting the changed data. Similarly, the director (156) updates a corresponding model to reflect and incorporate the data and schedule data publication to one or more publication platforms. In one embodiment, the content manager (152) may function in a sleep or hibernate mode when inactive, e.g. not collecting data, and may change to an active mode when changes to relevant or pertinent data are discovered. Accordingly, the content manager (152) functions as a tool to collect and organize data from one or more computing devices, with the director (156) reflecting the organized data into one or more models.

The platform monitoring conducted by the platform manager (154) is also referred to herein as platform analysis. This analysis is leveraged by the director (156) to create a measurement of impact of content publication. The impact measurement is conducted dynamically and is reflected by the director (156) in the corresponding platform model. The platform manager (154) identifies and analyzes published content, and leverages changes in the platform content to enable the director to dynamically derive or update the temporal delay for content publication, and reflect the assessed delay in one or more corresponding models. The director (156) orchestrates a sequence of actions, e.g. publication schedule, based on the derived model. It is understood that the published platform data is dynamic and may change in real-time, with such change affecting the published content (174). The model generates a policy reflected in the inferred temporal delay based on data obtained from the publication platform.

The monitoring conducted by the platform manager (154) is referred to herein as data mining and supervised learning, which may be conducted as one or more background processes. The director (156), which is shown herein operatively coupled to the platform manager (154), functions as a tool to dynamically derive a model to leverage both the platform data and the content to be published. The model leverages the current state of the platform and corresponding platform data to maximize utility of outcomes.

In one embodiment, the platform manager (154) enables and supports use of machine learning (ML) with respect to optimization of the platform data. A corresponding machine learning model (MLM) encapsulates a corresponding ML algorithm. The MLM functions to dynamically learn values of platform published content as the published content is subject to change. The platform manager (154) discovers and analyzes patterns. As patterns evolve, the platform manager (154) may communicate patterns and pattern changes to the director (156) as such patterns and pattern changes may need to be reflected in derivation of a model or amendment of an existing model. The platform manager (154) supports elasticity and the complex characteristics of platform publication and corresponding activities across a plurality of devices in the network. Accordingly, patterns of activity data are learned over time and used for dynamically orchestrating or amending the corresponding platform model.

As shown, the network (105) may include local network connections and remote connections in various embodiments, such that the knowledge engine (150) may operate in environments of any size, including local and global, e.g. the Internet. Additionally, the knowledge engine (150) serves as a front-end system that can make available a variety of knowledge extracted from or represented in network accessible sources and/or structured data sources. In this manner, some processes populate the knowledge engine (150), with the knowledge engine (150) also including input interfaces to receive requests and respond accordingly.

The knowledge base (160) is configured with logically grouped domains (162_{A})-(162_{C}) and corresponding models (166_{A})-(166_{C}), respectively, for use by the knowledge engine (150). In one embodiment, the knowledge base (160) may be configured with other or additional sources of input, and as such, the sources of input shown and described herein should not be considered limiting. Similarly, in one embodiment, the knowledge base (160) includes structured, semi-structured, and/or unstructured content related to activities and tasks. The various computing devices (180)-(190) in communication with the network (105) may include access points for the logically grouped domains and models. Some of the computing devices may include devices for a database storing the corpus of data as the body of information used by the knowledge engine (150) to generate response output (174) and to communicate the response output to a corresponding network device, such as a visual display (170), operatively coupled to the server (110) or one or more of the computing devices (180)-(190) across network connection (104).

The network (105) may include local network connections and remote connections in various embodiments, such that the knowledge engine (150) may operate in environments of any size, including local and global, e.g. the Internet. Additionally, the knowledge engine (150) serves as a front-end system that can make available a variety of knowledge extracted from or represented in network accessible sources and/or structured data sources. In this manner, some processes populate the knowledge engine (150), with the knowledge engine (150) also including one or more input interfaces or portals to receive requests and respond accordingly.

The knowledge engine (150), via a network connection or an internet connection to the network (105), is configured to detect and manage network activity and task data as related to publication platforms, such as social media platforms. The knowledge engine (150) may effectively orchestrate or optimize an orchestrated sequence of actions directed at related activity data by leveraging the knowledge base (160), which in one embodiment may be operatively coupled to the server (110) across the network (105).

The knowledge engine (150) and the associated tools (152)-(156) leverage the knowledge base (160) to support orchestration of a sequence of actions, and supervised learning to optimize the sequence of actions. The director (156) leverages the analysis conducted by the platform manager (154), and orchestrates or amends a model to schedule an action or a sequence of actions directed at deferred content publication. Accordingly, the tools (152)-(156) manage scheduling of content for publication by assessing the content to be published and orchestrating a schedule for content publication.

Publication platforms, such as social media platforms, are subject to change, and the platform manager (154) and the director (156) are configured to dynamically respond to detected changes. It is understood that as the platform content changes, a corresponding model may be subject to change. The platform manager (154) is configured to dynamically adjust to such changes.

Activity data, e.g. published platform data, received across the network (105) may be processed by a server (110), for example IBM Watson® server, and the corresponding knowledge engine (150). As shown herein, the knowledge engine (150) together with the embedded managers (152)-(154) and director (156) perform an analysis of the activity data, and dynamically conduct or update a corresponding model, as well as schedule content for publication. The function of the tools and corresponding analysis is to embed dynamic learning to separate content creation from content publication.

In some illustrative embodiments, the server (110) may be the IBM Watson® system available from International Business Machines Corporation of Armonk, N.Y., which is augmented with the mechanisms of the illustrative embodiments described hereafter. The manager (152)-(154) and director (156), hereinafter referred to collectively as tools, are shown as being embodied in or integrated within the knowledge engine (150) of the server (110). The tools may be implemented in a separate computing system (e.g., 190), or in one embodiment they can be implemented in one or more systems connected across network (105) to the server (110). Wherever embodied, the tools function to dynamically evaluate platform activity data to optimize content publication.

Types of devices and corresponding systems that can utilize the knowledge engine (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various devices and systems can be networked together using computer network (105). Types of computer network (105) that can be used to interconnect the various devices and systems include Local Area Networks (LANs), Wireless Local Area Networks (WLANs), the Internet, the Public Switched Telephone Network (PSTN), other wireless networks, and any other network topology that can be used to interconnect the devices and systems. Many of the devices and systems include nonvolatile data stores, such as hard drives and/or nonvolatile memory. Some of the devices and systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various devices and systems or can be internal to one of the devices and systems.

The device(s) and system(s) employed to support the knowledge engine (150) may take many forms, some of which are shown in FIG. 1. For example, an information handling system may take the form of a desktop, server, portable, laptop, notebook, or other form factor computer or data processing system. In addition, the device(s) and system(s) may take other form factors such as a personal digital assistant (PDA), a gaming device, ATM machine, a portable telephone device, a communication device or other devices that include a processor and memory.

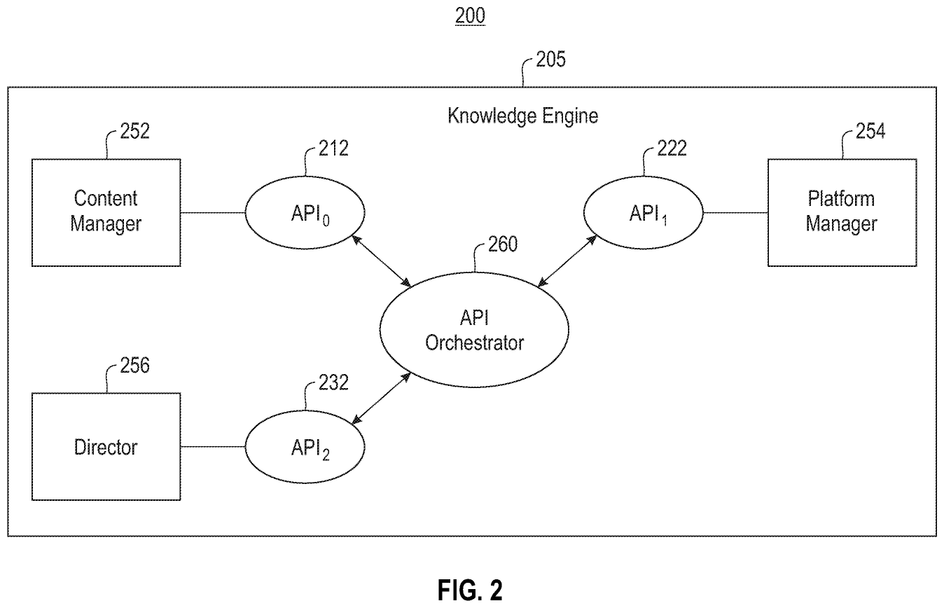

An Application Program Interface (API) is understood in the art as a software intermediary between two or more applications. With respect to the knowledge engine (150) shown and described in FIG. 1, one or more APIs may be utilized to support one or more of the tools (152)-(156) and their associated functionality. Referring to FIG. 2, a block diagram (200) is provided illustrating the tools (252)-(256) and their associated APIs. As shown, a plurality of tools is embedded within the knowledge engine (205), with the tools including the content manager (152) shown herein as (252) associated with API₀ (212), the platform manager (154) shown herein as (254) associated with API₁ (222), and the director (156) shown herein as (256) associated with API₂ (232). Each of the APIs may be implemented in one or more languages and interface specifications. API° (212) provides functional support to collect and collate platform activity and publication data across two or more domains and to support content publication scheduling. API₀ (212) provides function support to detect created content, e.g. non-published content; API₁ (222) provides functional support real-time monitoring and evaluation of publication platforms; and API₂ (232) provides functional support to dynamically derive a model and orchestrate a schedule for content publication. As shown, each of the APIs (212), (222), and (232) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

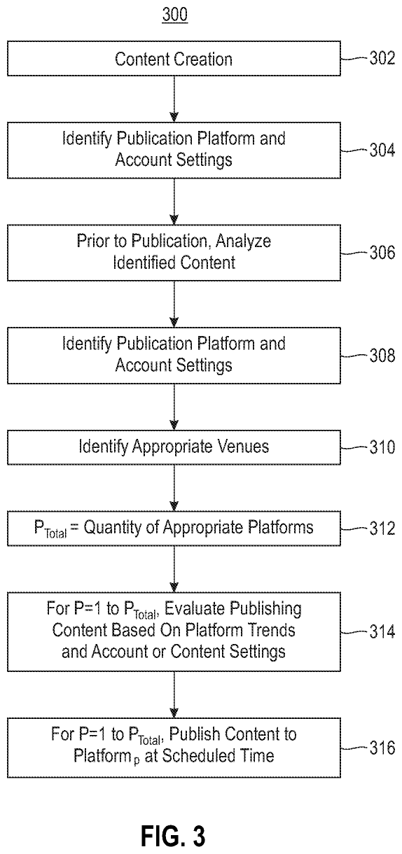

Referring to FIG. 3, a flow chart (300) is provided illustrating a process for scheduling content publication to a publication platform. As shown and described, the process detaches content creation from publication, thereby masking behavior, such as social media behavior. It is understood in the art that there are various different publication platforms, including but not limited to social media platforms, with each of the platforms comprised of account holders. An account holder on a first platform may be an account holder on a second platform, or in one embodiment may not be an account holder on a second platform. Similarly, different account holders may exhibit different characteristics with respect to their accounts. For example, an account holder may be interested in following content via topics or via trends. Similarly, an account holder may be interested in publishing content on a periodic basis or a non-periodic basis, or the account holder may be interested in publishing content with respect to a topic that is trending, or after such a trend has dissipated. Regardless for the basis of the account holder, the process shown herein leverages the characteristics of the account holder to schedule content publishing.

At some point in time, all content that is published to a platform is created. However, it is understood in the art, that content that has previously been created may be re-published. Whether the content is original and is in the process of being created or the content is designated to be re-published, the content is referred to collectively as content creation (302). An account for a publication platform is identified, and the account settings are determined (304). It is understood in the art that each account may have a plurality of settings. For the purpose of disclosure and relevancy, the account settings that are determined or otherwise identified are related to publishing content to the corresponding platform. The account settings are directed at characterizing the account holder on the corresponding platform. Examples of the account settings include, but are not limited to, trend follower, trend setter, and random. These are merely examples of account settings, and in one embodiment additional or alternative settings may be established or otherwise employed. It is understood that the account settings are configurable. Similarly, in one embodiment, the account holder may designate a setting for specific content. For example, in one embodiment, the account holder may assign created content to a designated setting prior to publishing, or as described herein prior to scheduling the content for publishing. As described in detail below, the account or content setting is a factor that is leveraged to schedule the content for publishing on one or more of the platforms. Accordingly, during content creation or detection of content creation the account or content settings corresponding to the content that is the subject or in the process of being created are identified and associated with the content.

The content identified at step (302) is subject to analysis prior to being published on any platform (306). This analysis includes evaluation of the content that is the subject of the publishing as well as the account settings. In one embodiment, natural language processing (NLP) is employed to interpret the content, including but not limited to, interpreting an expression. Similarly, in one embodiment, the publishing content may be subject to parsing to identify content components, parts of speech, analogies, patterns, expressions, etc. A sentence parsing tool, such as but not limited to slot grammar logic (SGL), is applied to the publishing content to separate the publishing content into its constituent parts to find the sentence parts and location sequence. According, one or more tools are utilized to parse the content and identify grammatical components and expressions therein.

As described above, there are multiple publication platforms, with each platform having different characteristics. Content published on a first platform may not be appropriate for content published on a second platform. For example, in one embodiment, the first platform is a casual platform and the second platform is directed at business and commercial venues. As such, in one circumstance content directed at a business venture may not be appropriate for the first and second platform, and in another circumstance the content directed at the business venture may be appropriate for both the first and second platforms. The analysis of the content at step (306) facilitates identifying appropriate platforms for publishing the content. Following step (306), the platforms that are available to receive the publishing content are identified (308). In one embodiment, the available platforms may be the platforms which have an account associated with the content creator. The availability at step (308) identifies each of those accounts. Following step (308), the available platforms are identified with respect to the evaluated publishing content to identify those platforms that are appropriate venues to receive the publishing content (310). The variable P_{Total} is assigned to represent the set of identified and appropriate platforms that will be the subject of consideration for publishing the created content (312). Accordingly, as part of the content analysis, the platforms available for publishing are evaluated with respect to appropriateness for publishing the content.

It is understood that content that is trending on one platform may overlap or may not overlap with content trending on another platform. As shown at step (304), the account or content settings are identified to ascertain how the content should be published with respect to trends and trending topics. For each of the identified platforms, P_{Total}, the publishing and specifically the publishing content is evaluated based on the platform trends and the account or content settings, with the evaluation deriving a model to infer a temporal delay for publishing the content on the respective platforms (314). A schedule is created for publishing the content on each of the respective and identified platforms based on the derived model and the inferred delay. The content is published to each of the identified platforms, P_{Total}, at the time identified in the schedule (316). The schedule may be a direct correspondence between the publishing content from an account to a single platform, but this embodiment should not be considered limiting. In one embodiment, the publishing content and corresponding schedule may identify multiple platforms and multiple accounts, with the publishing schedule taking place at or around the same time for at least two of the platforms, or at different times on different platforms. The created schedule may singularly identify or reflect one or more random times for publishing the content on one or more platforms. Accordingly, the schedule incorporates multiple characteristics of the content and the platforms to ascertain and organize a schedule for publishing the content.

It is understood that the platforms, and in one embodiment the platform content, are dynamic. As new content is received and published, the characteristics of the platform change. A topic that was trending yesterday may not be trending today. The schedule for publishing content that is created at step (314) is subject to change on a dynamic basis, the change based on platform characteristics, and in one embodiment platform trending or non-trending topics. At least two aspects are subject to monitoring with respect to the schedule and content publishing, including the temporal delays and the platform characteristics. In one embodiment, the schedule is dynamically modified commensurate with the dynamic characteristics of the respective platforms. Content publishing and publishing times as reflected in the schedule are considered in reference to each other and expected or experienced behavior of the platform for publishing content. Accordingly, the content is published based on the schedule date and time as identified in the schedule, or at an earlier point in time due to thresholds in the platform evaluation.

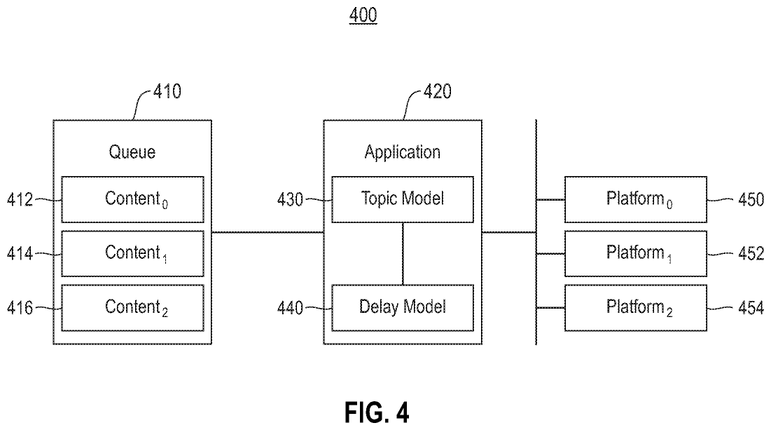

As shown in FIG. 3, content is created for publishing and subject to evaluation and schedule, effectively detaching content creation from content publication. Referring to FIG. 4, a flow diagram (400) is provided to illustrate an aspect of scheduling content for publishing on one or more publication platforms. Developed content is subject to analysis for publishing. As shown herein, a queue (410) is provided to receive or otherwise organize the publishing content. The queue (410) is shown with a plurality of publishing content, including content₀ (412), content₁ (414), and content₂ (416). The quantity of publishing content in the queue is for illustrative purposes and should not be considered limiting. In one embodiment, the queue organizes the received content based on the order of receipt, e.g. first-in-first-out, although in one embodiment an alternative order may be utilized. The content in the queue (410) is subject to processing, either individually or collectively. As shown, the queue (410) is operatively coupled to an application (420) to process the content. The application processing includes, but is not limited to, various forms of analysis. Examples of the content analysis include topic analysis of currently trending topic content and topic analysis of an outbound content publishing. The application (420) is shown herein with two models, including a topic model (430) and a delay model (440). As shown, the topic model (430) is operatively coupled to the delay model (440). The topic model (430) is derived to infer topic overlap between two or more content themes, e.g. corpora. The delay model (440) leverages the topic model (430) to infer a temporal delay for content publishing. In one embodiment, the topic model (430) and the delay model (440) may be combined into a single model. Accordingly, the application (420) processes content populated in the queue (410) and derives models, including one model (430) to infer topic overlap and another model (440) to infer temporal delay for content publishing.

The application (420) is shown operatively coupled to multiple media platforms, shown herein as platform₀ (450), platform₁ (452), and platform₂ (454). Although only three platforms are shown, this is for illustrative purposes and the quantity should not be considered limiting. The model(s) (430) and (440) are utilized to analyze the publishing content and to infer an optimal, or in one embodiment random, delay for publishing the content. Using the inferred delay, the application (420) forwards the publishing content from the queue (420) to designated platform(s), (450), (452), or (454). As shown and described in FIGS. 1 and 3, the publishing content can be sent to multiple designated platforms, for examples, platform₀ (450) and platform₂ (454). The publishing content can be sent to the designated platforms at different times, with their own publishing time, either based on a schedule or at random. Aspects of content publishing and corresponding scheduling of the publishing(s) is shown and described in FIG. 3. Accordingly, the application (420) interfaces with the queue (410) and the platforms (450)-(454), to analyze and manage scheduling of content posting, and to effectively separate content creation from publication.

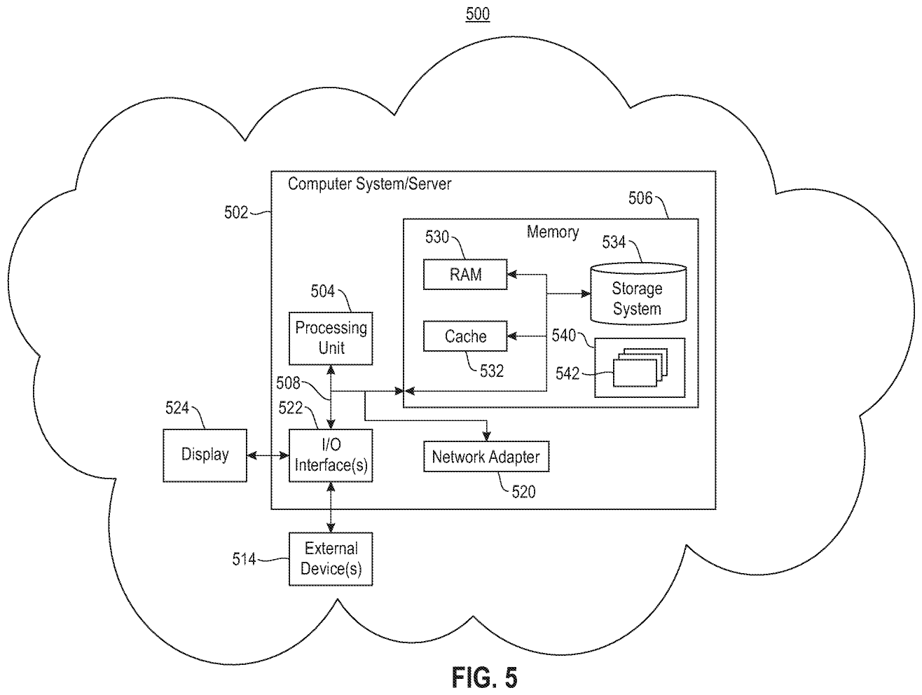

Embodiments shown and described herein may be in the form of a computer system for use with an intelligent computer platform for providing orchestration of activities across one or more domains to separate content creation from content publication. Aspects of the tools (152)-(156) and their associated functionality may be embodied in a computer system/server in a single location, or in one embodiment, may be configured in a cloud based system sharing computing resources. With references to FIG. 5, a block diagram (500) is provided illustrating an example of a computer system/server (502), hereinafter referred to as a host (502) in communication with a cloud based support system, to implement the system, tools, and processes described above with respect to FIGS. 1-4. Host (502) is operational with numerous other general purpose or special purpose computing system environments or configurations. Examples of well-known computing systems, environments, and/or configurations that may be suitable for use with host (502) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (502) may be described in the general context of computer system-executable instructions, such as program modules, being executed by a computer system. Generally, program modules may include routines, programs, objects, components, logic, data structures, and so on that perform particular tasks or implement particular abstract data types. Host (502) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, host (502) is shown in the form of a general-purpose computing device. The components of host (502) may include, but are not limited to, one or more processors or processing units (504), e.g. hardware processors, a system memory (506), and a bus (508) that couples various system components including system memory (506) to processor (504). Bus (508) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (502) typically includes a variety of computer system readable media. Such media may be any available media that is accessible by host (502) and it includes both volatile and non-volatile media, removable and non-removable media.

Memory (506) can include computer system readable media in the form of volatile memory, such as random access memory (RAM) (530) and/or cache memory (532). By way of example only, storage system (534) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (508) by one or more data media interfaces.

Program/utility (540), having a set (at least one) of program modules (542), may be stored in memory (506) by way of example, and not limitation, as well as an operating system, one or more application programs, other program modules, and program data. Each of the operating systems, one or more application programs, other program modules, and program data or some combination thereof, may include an implementation of a networking environment. Program modules (542) generally carry out the functions and/or methodologies of embodiments to dynamically orchestrate of activities across one or more domains to separate content creation from content publication. For example, the set of program modules (542) may include the tools (152)-(156) as described in FIG. 1.

Host (502) may also communicate with one or more external devices (514), such as a keyboard, a pointing device, etc.; a display (524); one or more devices that enable a user to interact with host (502); and/or any devices (e.g., network card, modem, etc.) that enable host (502) to communicate with one or more other computing devices. Such communication can occur via Input/Output (I/O) interface(s) (522). Still yet, host (502) can communicate with one or more networks such as a local area network (LAN), a general wide area network (WAN), and/or a public network (e.g., the Internet) via network adapter (520). As depicted, network adapter (520) communicates with the other components of host (502) via bus (508). In one embodiment, a plurality of nodes of a distributed file system (not shown) is in communication with the host (502) via the I/O interface (522) or via the network adapter (520). It should be understood that although not shown, other hardware and/or software components could be used in conjunction with host (502). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (506), including RAM (530), cache (532), and storage system (534), such as a removable storage drive and a hard disk installed in a hard disk drive.

Computer programs (also called computer control logic) are stored in memory (506). Computer programs may also be received via a communication interface, such as network adapter (520). Such computer programs, when run, enable the computer system to perform the features of the present embodiments as discussed herein. In particular, the computer programs, when run, enable the processing unit (504) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (502) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

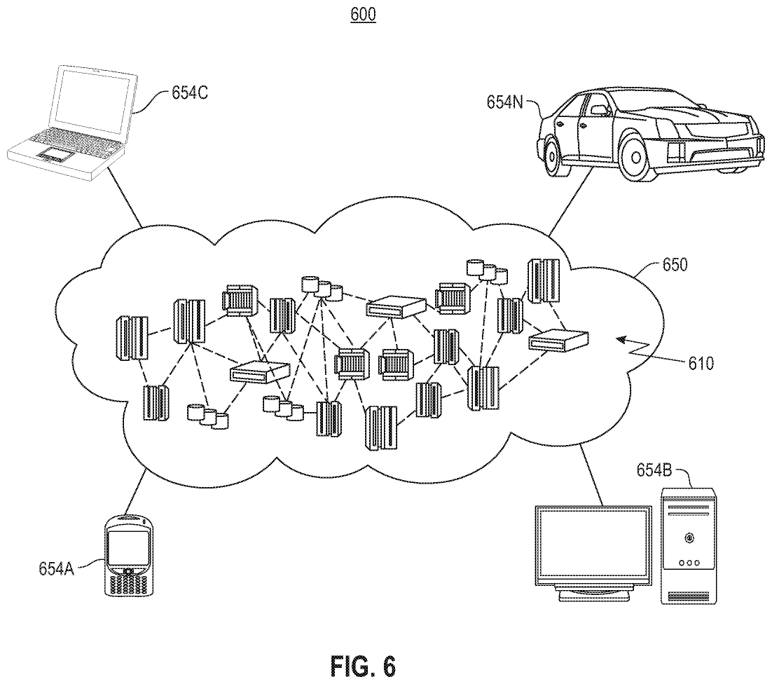

Referring now to FIG. 6, an illustrative cloud computing network (600). As shown, cloud computing network (600) includes a cloud computing environment (650) having one or more cloud computing nodes (610) with which local computing devices used by cloud consumers may communicate. Examples of these local computing devices include, but are not limited to, personal digital assistant (PDA) or cellular telephone (654A), desktop computer (654B), laptop computer (654C), and/or automobile computer system (654N). Individual nodes within nodes (610) may further communicate with one another. They may be grouped (not shown) physically or virtually, in one or more networks, such as Private, Community, Public, or Hybrid clouds as described hereinabove, or a combination thereof. This allows cloud computing environment (600) to offer infrastructure, platforms and/or software as services for which a cloud consumer does not need to maintain resources on a local computing device. It is understood that the types of computing devices (654A-N) shown in FIG. 6 are intended to be illustrative only and that the cloud computing environment (650) can communicate with any type of computerized device over any type of network and/or network addressable connection (e.g., using a web browser).

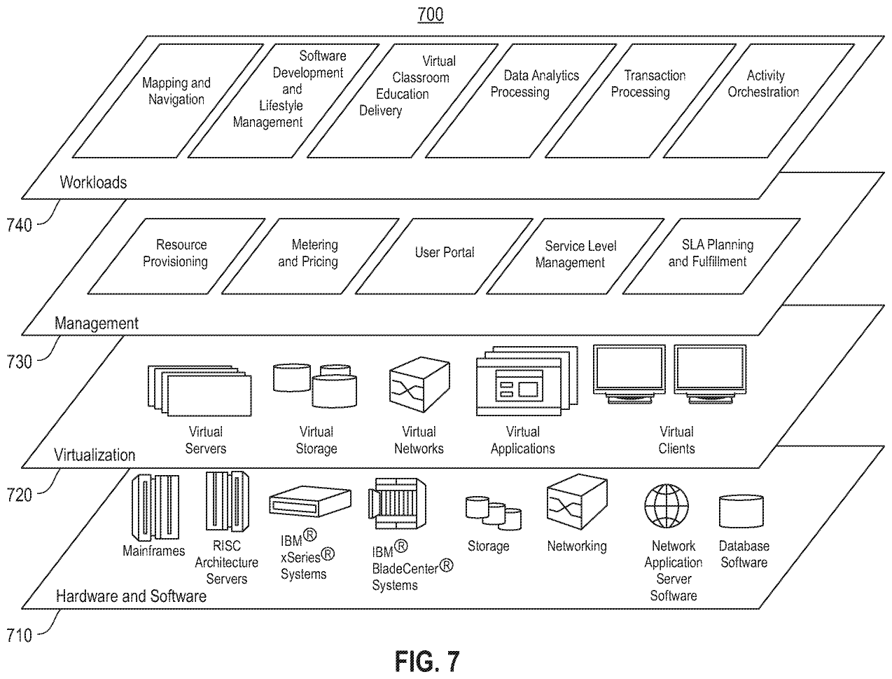

Referring now to FIG. 7, a set of functional abstraction layers (700) provided by the cloud computing network of FIG. 6 is shown. It should be understood in advance that the components, layers, and functions shown in FIG. 7 are intended to be illustrative only, and the embodiments are not limited thereto. As depicted, the following layers and corresponding functions are provided: hardware and software layer (710), virtualization layer (720), management layer (730), and workload layer (740).

The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and activity orchestration.

It will be appreciated that there is disclosed herein a system, method, apparatus, and computer program product for evaluating natural language input, detecting an interrogatory in a corresponding communication, and resolving the detected interrogatory with an answer and/or supporting content.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to improve the functionality and operation of an artificial intelligence platform to resolve orchestration of travel activities and meeting scheduling.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. The modeling identifies an optimal time for publication or posting in view of the real-time publication activity and characteristics associated with the content to be published. Accordingly, the scope of protection of the embodiments is limited only by the following claims and their equivalents.

What is claimed is:

1. A system comprising:
a processor operatively coupled to memory;
a knowledge engine in communication with the processing unit, the knowledge engine to separate content creation from content publication, the knowledge engine comprising:
a content manager to detect content creation prior to publishing the detected content on a platform;
a platform manager to monitor one or more publication platforms in real-time, the platform manager to identify and analyze published content on the one or more monitored publication platforms;
a director to derive a model to infer a temporal delay to publish the detected content to the one or more publication platforms subject to monitoring by the platform manager;
the director to schedule publication of the content detected by the content manager, the publication schedule based on the derived model and inferred temporal delay; and
publication of the detected content by the director to one or more designated publication platforms at a time identified by the inferred delay, wherein the publication separates content creation from content publication.

2. The system of claim 1, wherein the director derives a first temporal delay associated with a first publication platform and derives a second temporal delay associated with a second publication platform, the first temporal delay being different than the second temporal delay.

3. The system of claim 2, further comprising the director to publish the detected content to the first publication platform from a first account and publish the detected content to the second publication platform from a second account, the first and second accounts being separate accounts.

4. The system of claim 2, wherein the published schedule of the detected content is singular for multiple platforms and multiple accounts.

5. The system of claim 2, wherein the detected content includes a first content and a second content, the first and second content being different, and further comprising the director to:
evaluate characteristic data of the first and second content;
infer first and second temporal delays for publication of the first and second content; and
coordinate the first and second temporal delays to the first and second platforms based on the content evaluation and expected platform behavior.

6. The system of claim 1, wherein the publication platform is a social media platform and publication of the detected content with respect to the inferred temporal delay masks social media behavior.

7. The system of claim 1, wherein the inferred temporal delay is random.

8. A computer program product to separate content creation from content publication, the computer program product comprising a computer readable storage medium having program code embodied therewith, the program code executable by a processor to:
detect content creation prior to publishing the detected content on a publication platform;
monitor one or more publication platforms in real-time, including identify and analyze published content on the one or more monitored publication platforms;
derive a model to infer a temporal delay to publish the detected content to the one or more publication platforms subject to monitoring;
schedule publication of the content detected by the content manager, the publication schedule based on the derived model and inferred temporal delay; and
publication of the detected content to one or more designated publication platforms at a time identified by the inferred delay, wherein the publication separates content creation from content posting.

9. The computer program product of claim 8, further comprising program code to derive a first temporal delay associated with a first publication platform and derive a second temporal delay associated with a second publication platform, the first temporal delay being different than the second temporal delay.

10. The computer program product of claim 9, further comprising program code to publish the detected content to the first publication platform from a first account and publish the detected content to the second publication platform from a second account, the first and second accounts being separate accounts.

11. The computer program product of claim 9, wherein the published schedule of the detected content is singular for multiple platforms and multiple accounts.

12. The computer program product of claim 9, wherein the detected content includes a first content and a second content, the first and second content being different, and further comprising program code to:
evaluate characteristic data of the first and second content;
infer first and second temporal delays for publication of the first and second content; and
coordinate the first and second temporal delays to the first and second platforms based on the content evaluation and expected platform behavior.

13. The computer program product of claim 8, wherein the publication platform is a social media platform and publication of the detected content with respect to the inferred temporal delay masks social media behavior.

14. The computer program product of claim 8, wherein the inferred temporal delay is random.

15. A computer implemented method comprising:
detecting content creation prior to publishing the content to a publication platform;
monitoring one or more publication platforms in real-time, including identifying published content on the monitored publication platforms;
analyzing the one or more monitored publication platforms with respect to the published content;
deriving a model to infer a temporal delay for publishing the detected content to the one or more monitored publication platforms;
scheduling publishing of the detected content based on the derived model and inferred delay; and
publishing the detected content to one or more designated publication platforms at a time identified by the inferred delay, wherein publishing the content separates content creation from content publishing.

16. The method of claim 15, further comprising deriving a first temporal delay associated with a first publication platform and deriving a second temporal delay associated with a second publication platform, the first temporal delay being different than the second temporal delay.

17. The method of claim 16, further comprising publishing the detected content to the first publication platform from a first account and publishing the detected content to the second publication platform from a second account, the first and second accounts being separate accounts.

18. The method of claim 16, wherein the scheduling of the publishing of the detected content is singular for multiple publication platforms and multiple accounts.

19. The method of claim 16, wherein the detected content includes first content and second content, the first and second content being different, and further comprising:
scheduling including evaluating characteristic data of the first and second content;
inferring first and second temporal delays for publishing the first and second content; and
coordinating the first and second temporal delays to the first and second publication platforms based on the content evaluation and expected platform behavior.

20. The method of claim 15, wherein the publication platform is a social media platform and publishing the detected content with respect to the inferred temporal delay masks social media behavior.
